(19) United States
(12) Patent Application Publication
(10) Pub. No.: US 2016/0342945 A1
(43) Pub. Date: Nov. 24, 2016

(54) METHOD FOR GENERATING VERIFIABLE CONDITION REPORTS INDICATING A CONDITION OF A TITLE VEHICLE

(71) Applicants: Klaus Doranth, Palmetto, FL (US); Donald Power, JR., Bradenton, FL (US)

(72) Inventors: Klaus Doranth, Palmetto, FL (US); Donald Power, JR., Bradenton, FL (US)

(21) Appl. No.: 14/714,429

(22) Filed: May 18, 2015

(51) Int. Cl. G06Q 10/08; H04L 29/06; H04L 29/08; G06F 17/30

(52) U.S. Cl. CPC G06Q 10/0838; G06F 17/30241; H04L 63/083; H04L 63/0876; G06F 17/30876; G06F 17/30867; G06F 17/30371; H04L 67/06

(57) ABSTRACT

A mobile device for creating a verifiable condition report. The mobile device includes a geolocation module and recording module for including in the verifiable condition report geolocation data and files evidencing a condition of a target object, respectively. The mobile device also includes a network interface for transmitting the verifiable condition report to a server.

### TECHNICAL FIELD

The present invention relates generally to verifiable condition reports, in particular to authenticatable electronic vehicle condition reports.

### BACKGROUND

When transporting a vehicle, the transporter completes various paper condition and specification reports (CSR) using hundreds of conditional codes, measurements, and by drawing and writing on vehicle images. The process of generating a CSR is time consuming and often results in a document that is only meaningful to the individual filling out the CSR. That is, often transporters fill out reports quickly using abbreviations and symbols that are illegible or meaningless to the person receiving the vehicle.

When a purchaser receives a transported vehicle, they are provided a copy of the CSR. This way, if there is damage to the vehicle, the purchaser can review the CSR to determine if the vehicle was damaged when received by the transporter or if the vehicle was damaged during transportation by the transporter.

### SUMMARY

Because CSR are created by a transporter drawing and writing on a piece of paper, there is no way to ensure that the transporter filled out the CSR before transporting the vehicle. There is also no way to ensure that the transporter accurately filled out the CSR.

There are a number of issues that arise from using unverifiable CSR. When a transporter delivers a vehicle, it is often hours or days later that the owner of the vehicle is given the opportunity to inspect the vehicle, and there are many times that the owner of the vehicle does not have the opportunity to do a thorough inspection prior to pick up. When there is possible transport damage found on a vehicle, the owner starts by calling the transporter to obtain a copy of the CSR or retrieves the CSR included with the vehicle at delivery. As described above, the CSR is primarily hand written on generic forms.

If a dispute arises, there is a signature from the individual who delivered the vehicle to the transporter. However, it is often difficult to determine who signed the CSR at the beginning of the transport process. It is also difficult to determine when and/or where the CSR was created. For example, it may not be possible to determine if the transporter created or modified the CSR days after beginning to transport the vehicle and after the transporter dropped a bar on the roof and dented or scratched the vehicle.

The present disclosure presents a method and device for creating a verifiable condition report for verifying the condition of a vehicle at a point in time using geolocation data, an individual identifier, and condition filed evidencing the condition of the vehicle.

According to one aspect of the disclosure, there is provided a mobile device configured to generate a verifiable condition report. The mobile device includes a geolocation module configured to output geolocation data indicating a position of the mobile device. The mobile device also includes a recording module configured to output condition files evidencing a condition of a target object. The mobile device further includes a non-transitory computer readable medium configured to store a template condition report, wherein the template verifiable condition report identifies multiple conditions. The mobile device also includes a processor configured to generate the verifiable condition report from the template condition report by: instantiating the template verifiable condition report as the verifiable condition report; determining current date information; storing the current date information as a creation date in the verifiable condition report; receiving geolocation data from the geolocation module; storing the geolocation data as a creation location in the verifiable condition report; determining an individual identifier associated with either the mobile device or a user of the mobile device; storing the individual identifier in the verifiable condition report; receiving and storing the unique identifier of the subject object in the verifiable condition report; receiving condition files from the recording module evidencing a particular condition of the subject object; associating each of the condition files with at least one of the multiple conditions of the subject object; and embedding the associated condition files within the verifiable condition report. The mobile device further includes a network interface configured to transmit the verifiable condition report.

Alternatively or additionally, the individual identifier comprises at least one of a mobile device identifier identifying the mobile device or a user identifier identifying the user of the mobile device.

Alternatively or additionally, the processor receives the user identifier and a password, causes the network interface to transmit the received user identifier and the password to an authenticating server, and receives a verification from the authenticating server via the network interface when the user identifier and the password are valid.

Alternatively or additionally, the mobile device identifier comprises a serial number or MAC address of the mobile device.

Alternatively or additionally, the geolocation module comprises a GPS receiver.

Alternatively or additionally, the recording module comprises an image capturing module, a video capturing module, or an audio capturing module.

According to another aspect of the disclosure, there is provided a method for generating a verifiable condition report using a mobile device. The method includes accessing a template verifiable condition report from a non-transitory computer readable medium of the mobile device. The template verifiable condition report identifies multiple conditions. The method also includes instantiating the template verifiable condition report as the verifiable condition report. The method further includes querying a processor of the mobile device to determine current date information and storing the current date information as a creation date in the verifiable condition report. The method additionally includes querying a geolocation module of the mobile device to determine geolocation data indicating a position of the mobile device, storing the geolocation data as a creation location in the verifiable condition report, determining an individual identifier associated with either the mobile device or a user of the mobile device, and storing the individual identifier in the verifiable condition report. The method also includes querying a user of the mobile device for a unique identifier of a subject object, receiving and storing the unique identifier of the subject object in the verifiable condition report, querying a user of the mobile device regarding the multiple conditions of the subject object included in the verifiable condition report, receiving condition files evidencing a particular condition of the subject object from a recording module of the mobile device, associating each of the condition files with at least one of the multiple conditions of the subject object, embedding the associated condition files within the verifiable condition report, and transmitting the verifiable condition report via a network interface of the mobile device.

Alternatively or additionally, the individual identifier comprises at least one of a mobile device identifier identifying the mobile device or a user identifier identifying the user of the mobile device.

Alternatively or additionally, the mobile device identifier comprises a serial number or MAC address of the mobile device.

Alternatively or additionally, the geolocation module comprises a GPS receiver.

Alternatively or additionally, the recording module comprises an image capturing module, a video capturing module, or an audio capturing module.

According to a further aspect of the disclosure, there is provided a method for creating and validating a verifiable condition report. The method includes generating a verifiable condition report using a mobile device and receiving the verifiable condition report. For each of the multiple conditions identified in the verifiable condition report, the method causes to be displayed to a user the condition files associated with a particular condition of the subject object and receiving an indication from the user regarding whether the condition files associated with the particular condition of the subject object match a current condition of the subject object. If the received indication from the user identifies a discrepancy between the verifiable condition report and the current condition of the subject object, then the message includes flagging the verifiable condition report, generating at least one new condition file evidencing the condition of the subject object associated with the discrepancy, and updating the verifiable condition report to include the at least one new condition file. If the received indication from the user does not identify a discrepancy between the verifiable condition report and the current condition of the subject object, then the method includes identifying the verifiable condition report as approved. The method further includes storing the verifiable condition report.

Alternatively or additionally, the verifiable condition report is received by a portable device and the at least one new condition file are generated by an image forming device, a video forming device, or an audio forming device of the portable device.

Alternatively or additionally, the verifiable condition report is transmitted by a communication interface of the portable device to a server.

According to another aspect of the disclosure, there is provided a system configured to create and validate a verifiable condition report. The system includes a mobile device, a server, and a portable device. The mobile device includes a geolocation module configured to output geolocation data indicating a position of the mobile device, a recording module configured to output condition files evidencing a condition of a target object, and a non-transitory computer readable medium configured to store a template condition report. The template verifiable condition report identifies multiple conditions. The mobile device also includes a processor configured to generate the verifiable condition report from the template condition report by: instantiating the template verifiable condition report as the verifiable condition report; determining current date information; storing the current date information as a creation date in the verifiable condition report; receiving geolocation data from the geolocation module; storing the geolocation data as a creation location in the verifiable condition report; determining an individual identifier associated with either the mobile device or a user of the mobile device; storing the individual identifier in the verifiable condition report; receiving and storing the unique identifier of the subject object in the verifiable condition report; receiving condition files from the recording module evidencing a condition of the subject object; associating each of the condition files with at least one of the multiple conditions of the subject object; and embedding the associated condition files within the verifiable condition report. The mobile device further includes a network interface configured to transmit the verifiable condition report to a server. The server includes: a connection interface configured to receive the verifiable condition report, and a non-transitory computer readable memory configured to store the received verifiable condition report. The connection interface is further configured to transmit the verifiable condition report to a portable device. The portable device including: a communication interface configured to receive the verifiable condition report, and a processor. The processor is configured to flag or approve the verifiable condition report by receiving the verifiable condition report and, for each of the multiple conditions identified in the verifiable condition report, causing to be displayed to a user of the portable device the condition files associated with a particular condition of the subject object and receiving an indication from the user regarding whether the condition files associated with the particular condition of the subject object match a current condition of the subject object. If the received indication from the user identifies a discrepancy between the verifiable condition report and the current condition of the subject object, the processor is configured to: flag the verifiable condition report, generate at least one new condition file evidencing the condition of the subject object associated with the discrepancy, and update the verifiable condition report to include the at least one new condition file. If the received indication from the user does not identify a discrepancy between the verifiable condition report and the current condition of the subject object, then the processor is configured to identify the verifiable condition report as approved. The portable device also includes a non-transitory computer readable medium configured to store the flagged or approved identified verifiable condition report.

Alternatively or additionally, the individual identifier comprises at least one of a mobile device identifier identifying the mobile device or a user identifier identifying the user of the mobile device.

Alternatively or additionally, the processor of the mobile device: receives the user identifier and a password, causes the network interface to transmit the received user identifier and the password to an authenticating server, and receives a verification from the authenticating server via the network interface when the user identifier and the password are valid.

Alternatively or additionally, the mobile device identifier comprises a serial number or MAC address of the mobile device.

Alternatively or additionally, the geolocation module comprises a GPS receiver.

Alternatively or additionally, the recording module comprises an image capturing module, a video capturing module, or an audio capturing module.

A number of features are described herein with respect to embodiments of the present disclosure; it will be appreciated that features described with respect to a given embodiment also may be employed in connection with other embodiments.

The present disclosure includes the features described herein, including the description, the annexed drawings, and, if appended, the claims, which set forth in detail certain illustrative embodiments. These embodiments are indicative, however, of but a few of the various ways in which the principles of the present disclosure may be employed.

### BRIEF DESCRIPTION OF THE FIGURES

FIG. 1 depicts an embodiment of a system for creating and validating a verifiable condition report.

FIG. 2A depicts an exemplary verifiable condition report.

FIG. 2B depicts an exemplary updated verifiable condition report created from the verifiable condition report of FIG. 2A.

FIG. 3 shows a block diagram illustrating a method for generating a verifiable condition report.

FIG. 4 shows a block diagram illustrating a method for creating and validating a verifiable condition report.

### DETAILED DESCRIPTION

The present disclosure describes a mobile device for creating a verifiable condition report. The mobile device includes a geolocation module and recording module for including in the verifiable condition report geolocation data and files evidencing a condition of a target object, respectively. The mobile device also includes a network interface for transmitting the verifiable condition report to a server.

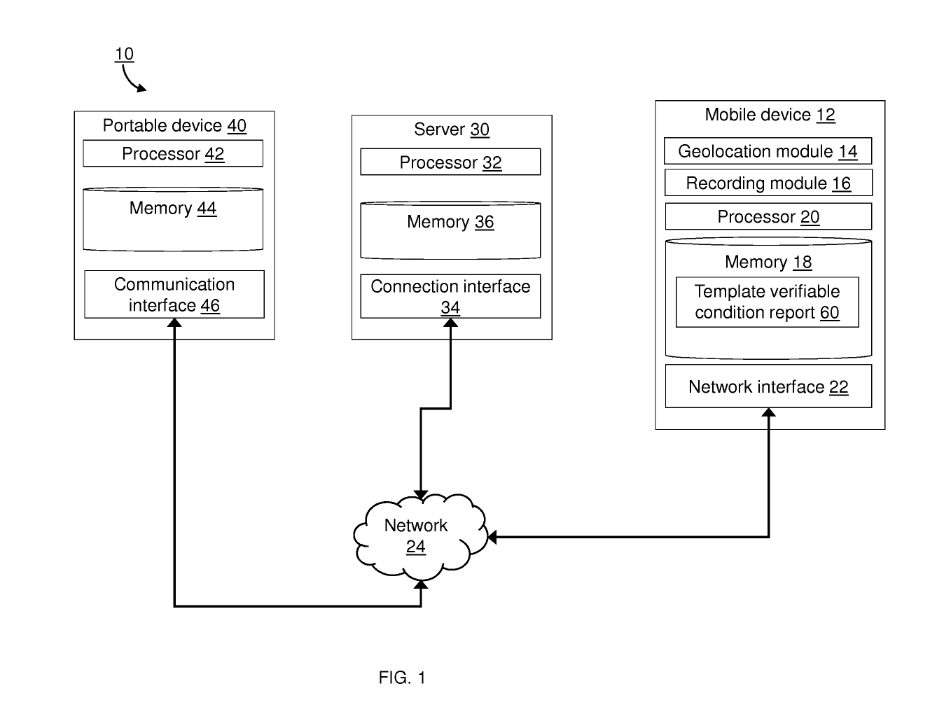

Turning initially to FIG. 1, a system 10 for creating and validating a verifiable condition report is shown. The system 10 includes a mobile device 12, server 30, and portable device 40. The mobile device 12 generates a verifiable condition report 62 evidencing a condition of a subject object. The mobile device 12 transmits the verifiable condition report 62 to the server 30 via a network 24. The server 30 transmits the verifiable condition report 62 via the network 24 to the portable device 40. A user of the portable device 40 compares the current condition of the subject object to the condition of the subject object specified in the verifiable condition report 62. If there are discrepancies between the actual condition of the subject object and the verifiable condition report 60, then the verifiable condition report 62 is flagged and updated to evidence the current condition of the subject object.

The mobile device 12 includes a geolocation module 14, recording module 16, non-transitory computer readable medium (memory) 18, processor 20, and network interface 22. The geolocation module 14 is configured to output geolocation data indicating a position of the mobile device 14. The geolocation data may provide a longitude and latitude for the mobile device 12. For example, the geolocation module 14 may be a hardware location device such as a global positioning system (GPS) receiver, a Global Navigation Satellite System device, a Galileo positioning system device, a Compass navigation system device, an Indian Regional Navigational Satellite System device, or any other suitable device. Upon receiving a request for a physical location, the geolocation module 14 provides the processor 20 geolocation data designating the physical location of the mobile device 12.

The recording module 16 is configured to output condition files 72 evidencing a condition of a target object. The condition files 72 output by the recording module 16 may comprise still images, recorded video, audio recordings, and/or any other data files suitable to determine the condition of a subject object. For example, the recording module 16 may comprise an image capturing module such as a camera that is used to evidence damage to the body of a vehicle. In this example, each condition file 72 may comprise a different perspective of the subject object. As another example, the recording module 16 may comprise an audio recorder used to evidence the fact that the engine of the vehicle is operational. In still another example, the recording module 16 may comprise a video camera used to capture video depicting the condition of the body of a vehicle and record audio of the engine running. As will be understood by one of ordinary skill in the art, the recording module 16 is not limited to one of the examples listed above, but may comprise one or more of the above examples. Similarly, the condition files 72 output by the recording module 16 may comprise a mix of audio recordings, video recordings, still images, etc.

The memory 18 is configured to store a template condition report 60 that the processor 20 uses to generate the verifiable condition report 62. The template verifiable condition report 60 identifies multiple conditions. As will be understood by one of ordinary skill in the art, the memory 18 may be one or more of a buffer, a flash memory, a hard drive, a removable media, a volatile memory, a non-volatile memory, a random access memory (RAM), or other suitable device. In a typical arrangement, the memory 18 may include a non-volatile memory for long term data storage and a volatile memory that functions as system memory for the processor 20. The memory 18 may exchange data with the processor 20 over a data bus. Accompanying control lines and an address bus between the memory 18 and the processor 20 also may be present. The memory 18 is considered a non-transitory computer readable medium.

The multiple conditions may include the state of the physical components of the subject object. For example, the multiple conditions may include the state of the front bumper, glass, rear bumper, engine, etc. The multiple conditions may also include the presence of different options. For example, the multiple conditions may include the presence of airbags, a navigation system, four wheel drive, air conditioning, two master keys, a manual, etc.

In addition to storing the template verifiable condition report 60, the memory 18 may also store the verifiable condition report 62, condition files 72, executable programs, operating system files, etc.

The template verifiable condition report 60 may comprise one or more templates. For example, the template verifiable condition report 60 may include a different template for different types of subject objects. For example, the template verifiable condition report 60 may include separate templates for motorcycles, boats, cars, airplanes, trucks, recreational vehicles (RVs), all-terrain vehicles (ATVs), etc. The template verifiable condition report 60 may also include different templates for different circumstances. For example, there may be separate templates for use with automobiles. The separate templates may be for particular circumstances such as auctions, transport, etc.

The processor 20 is configured to generate a verifiable condition report 62 from the template condition 60. The processor 20 is configured to instantiate the template verifiable condition report 60 as the verifiable condition report 62. For example, the processor 20 may create a duplicate of the template verifiable condition report 60 that is then used as the verifiable condition report 62. The processor then stores various information in this verifiable condition report 60.

As will be understood by one of ordinary skill in the art, the processor 20 may have various implementations. For example, the processor 20 may include any suitable device, such as a programmable circuit, integrated circuit, memory and I/O circuits, an application specific integrated circuit, microcontroller, complex programmable logic device, other programmable circuits, or the like. The processor 20 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor. The processor 20 may be communicatively coupled to the computer readable medium 18 and network interface 22 through a system bus, mother board, or using any other suitable structure known in the art.

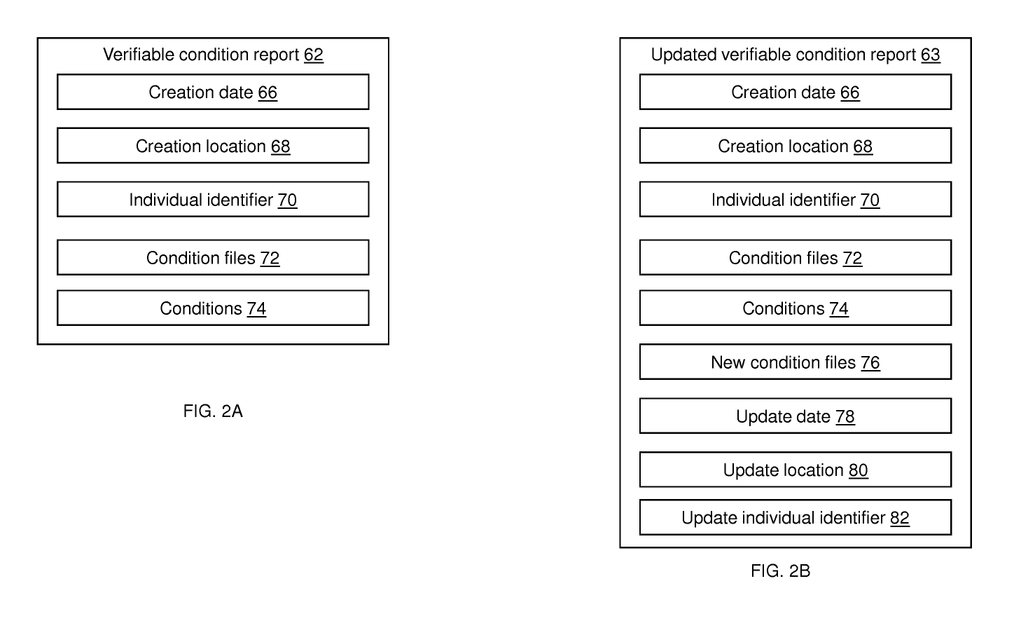

Turning to FIG. 2A, an exemplary verifiable condition report 62 is shown. The processor 20 is configured to determine current date information and store this information as a creation date 66 in the verifiable condition report 62. The processor 20 may, e.g., determine the current date information by accessing a system clock or by connecting to an external device. The current date information may include the current date, the current time, or the current date and time.

The processor 20 is further configured to receive geolocation data from the geolocation module 14 and store the geolocation data as a creation location 68 in the verifiable condition report 62. The creation date 66 and the creation location 68 may be used to verify that the verifiable condition report 62 was created at a given time and at a given location. For example, if the subject object of the verifiable condition report 62 is a car being transported, the creation date 66 may be used to ensure that the verifiable condition report 62 was created prior to transporting the vehicle. In this example, the creation location 68 may similarly be used to ensure that the verifiable condition report 62 was created at the location the vehicle was picked up from.

The processor 20 is also configured to determine an individual identifier 70 associated with either the mobile device 12 or a user of the mobile device and store the individual identifier 70 in the verifiable condition report. The individual identifier may comprise at least one of a mobile device identifier identifying the mobile device or a user identifier identifying the user of the mobile device. The user identifier may be received from the user along with a password. The processor 20 causes the network interface 22 to transmit the received user identifier, the password, and the mobile device identifier to an authenticating server. The processor 20 receives a verification from the authenticating server via the network interface 22 when the user identifier and the password are valid. The authenticating server may determine that the user identifier and password are valid if the combination of the user identifier and password match an entry in a database of user names and passwords stored by the authenticating server. The mobile device identifier may comprise a serial number, MAC address, or any suitable data capable of uniquely identifying the mobile device 10. The user identifier may comprise at least one a biometric identifications of the user (e.g., a fingerprint or retinal scan), a username, or a password. The biometric identifications may be acquired using a fingerprint scanner, touchscreen, a camera, or any other suitable hardware configured to obtain the biometric identifier. The mobile device identifier may be tied to a verifiable identity of a user. In one example, the mobile device identifier may be associated with a user name. If a user logs in from a mobile device having an identifier that does not match the mobile device identifier associated with the supplied user name, then the user may be prevented from logging in. Alternatively, two factor authentication may be performed in which an email or text message may be sent to a phone number or email address associated with the user name requesting that the user confirm that they are attempting to log in from a new device. If the user confirm that they are attempted to log in from a new device, then the user may be logged in.

The processor 20 is also configured to receive and store a unique identifier of the subject object in the verifiable condition report 62. The unique identifier may comprise a VIN number, serial number, or any other suitable identifier capable of uniquely identifying the subject object. The unique identifier may be input by a user. For example, a user may input via a keyboard a VIN number of a vehicle. Alternatively, the user may be presented with a list of vehicles. The user may then select one of the presented vehicles. In this example, the unique identifier may already be stored and associated with the presented vehicles. The unique identifier may also be input by the user by using the mobile device to scan in a bar code that contains the unique identifier.

The processor 20 is further configured to receive condition files 72 from the recording module 16 evidencing a condition of the subject object. The processor associates each of the condition files 72 with at least one of the multiple conditions of the subject object. For example, the verifiable condition report 62 may identify the condition of the front bumper, rear bumper, side panels, doors, all glass, and tires. The processor 20 may associate an image received of the front of the car from the recording module 16 with the condition of the front bumper and glass. Similarly, the processor may associate an image received of a zoomed in view of the rear windshield showing a crack with the condition of the glass. In this way, each condition file 72 may be associated with more than one condition.

The processor 20 may determine the condition to associate a given condition file 72 with by querying a user. For example, a user may manually assign a given condition file 72 to one or more conditions. Alternatively, the user may be instructed to capture images of a perspective of the vehicle or of, e.g., the front bumper and any images captured by the user after receiving such an instruction may be associated with the perspective or condition of the front bumper, respectively. After the user indicates that he/she is done capturing condition files 72 associated with the front bumper, the processor 20 may instruct the user to capture condition files 72 related to another condition.

The processor 20 is configured to embed the associated condition files 72 within the verifiable condition report 62. As will be understood by one of ordinary skill in the art, the processor 20 is configured to embed the associated condition files 72 in any suitable manner. For example, embedding the associated condition files 72 within the verifiable condition report 62 may refer to the condition files 72 being included in the verifiable condition report 62 such that the report appears as a single file. Alternatively, embedding the associated condition files 72 within the verifiable condition report 62 may refer to the condition files being linked to the verifiable condition report 72, with the condition files stored as separate files.

The mobile device 12 also includes a network interface 22 configured to transmit the verifiable condition report 62. The network interface 22 may transmit the verifiable condition report 62 to a server 30 via a network 24. As will be understood by one of ordinary skill in the art, the network interface 22 may comprise a wireless network adaptor, an Ethernet network card, a cellular data interface, or any suitable device that provides an interface between the server 30 and the network 24. The network interface 22 may be communicatively coupled to the memory 18, such that the network interface 22 is able to send data stored on the memory 18 across the network 24 and store received data on the memory 18. The network interface 22 may also be communicatively coupled to the processor 20 such that the processor 20 is able to control operation of the network interface 22. The network interface 22, memory 18, and processor 20 may be communicatively coupled through a system bus, mother board, or using any other suitable manner as will be understood by one of ordinary skill in the art.

The server 30 may include a processor 32, connection interface 34, and a non-transitory computer readable medium (memory) 36. The memory 36 may be embodied in a similar manner as described above regarding memory 18. Similarly, the connection interface 34 may be embodied in a similar manner as described above regarding the network interface 22. The connection interface 34 is configured to receive the verifiable condition report 62 and transmit the verifiable condition report 62 (e.g., to the portable device 40). The memory 36 is configured to store the received verifiable condition report 62. The stored verifiable condition reports 62 may be searchable such that a user may be able to search for a verifiable condition report 62 stored for a given vehicle.

The portable device 40 includes a processor 42, a non-transitory computer readable medium (memory) 44, and a communication interface 46. The memory 44 may be embodied in a similar manner as described above regarding memory 18. Similarly, the communication interface 46 may be embodied in a similar manner as described above regarding the network interface 22. The communication interface 46 is configured to receive the verifiable condition report 60. After receiving the verifiable condition report, the processor 42 is configured to approve or flag the verifiable condition report 62. For each of the multiple conditions identified in the verifiable condition report 62, the processor is configured to cause to be displayed to a user of the portable device the condition files 72 associated with a particular condition 74 of the subject object. The condition files 72 may be displayed to the user via a display (not shown) of the portable device 40.

The processor 42 of the portable device 40 is configured to receive an indication from the user (e.g., via user input) regarding whether the condition files 72 associated with the particular condition 74 of the subject object match a current condition of the subject object. For example, the user may select the particular condition 74 evidenced by the condition files 72 that does not match the current condition of the subject object. If the received indication from the user identifies a discrepancy between the verifiable condition report 62 and the current condition of the subject object, then the processor is configured to flag the verifiable condition report 62. Flagging the verifiable condition report 62 may be performed using any suitable method. For example, flagging the verifiable condition report 62 may comprise setting a value of a variable stored in the verifiable condition report 62 to true or false.

If a discrepancy is identified, the processor 42 is also configured to generate new condition files 76 evidencing the condition of the subject object associated with the discrepancy. For example, if the verifiable condition report 62 identifies the condition of the front bumper as undamaged, but the current condition of the front bumper is dented, then the processor 42 may instruct a user of the portable device 42 to capture new condition files 76 using a recording module (not shown) of the portable device 42. The processor 42 then updates the verifiable condition report 62 to create an updated verifiable condition report 62 including the new condition files 76. The new condition files 76 may be embodied in a similar manner as described above regarding the condition files 72. Similarly, the recording module of the portable device 40 may be embodied in a similar manner as described above regarding the recording module 16 of the mobile device 12.

With reference to FIG. 2B, an exemplary updated verifiable condition report 63 is shown. Creating the updated verifiable condition report 63 may include storing an update date 78, update location 80, and update individual identifier 82. The processor 42 is configured to determine current date information and store this information as the update date 78 in the verifiable condition report 62. The processor 42 may, e.g., determine the current date information by accessing a system clock or by connecting to an external device. The current date information may include the current date, the current time, or the current date and time.

The processor 42 is further configured to receive geolocation data from a geolocation module (not shown) of the portable device 40 and store the geolocation data as the update location 80 in the update verifiable condition report 63.

The processor 42 is also configured to determine an update individual identifier 82 associated with either the portable device 40 or a user of the portable device and store the update individual identifier 82 in the update verifiable condition report 63. The update individual identifier may comprise at least one of a portable device identifier identifying the portable device or a user identifier identifying the user of the portable device. The user identifier may be received from the user along with a password. The processor 42 causes the communication interface 46 to transmit the received user identifier and the password to an authenticating server. The processor 42 receives a verification from the authenticating server via the communication interface 46 when the user identifier and the password are valid. The authenticating server may determine that the user identifier and password are valid if the combination of the user identifier and password match an entry in a database of user names and passwords stored by the authenticating server. The mobile device identifier may comprise a serial number, MAC address, or any suitable data capable of uniquely identifying the portable device 40.

If the indication received by the processor 42 from the user does not identify a discrepancy between the verifiable condition report 62 and the current condition of the subject object, then the processor is configured to identify the verifiable condition report 62 as approved. Identifying the verifiable condition report 62 as approved may be performed using any suitable method. For example, identifying the verifiable condition report 62 as approved may comprise setting a value of a variable stored in the verifiable condition report 62 to true or false.

The processor 42 is also configured to cause the memory 44 to store the flagged or approved verifiable condition report 62.

The verifiable condition report 62 may be created by the mobile device 10 such that the report cannot be edited after the report has been completed. For example, after a user has indicated that he/she have completed the verifiable condition report 62, the verifiable condition report 62 may be locked such that it is not possible to edit the verifiable condition report 62. In this example editing the verifiable condition report 62 is distinguished from updating the verifiable condition report 62 by the portable device 40. Editing may refer to changing the content of the verifiable condition report 62 in such a way that the edits to the verifiable condition report 62 appears as if entered into the verifiable condition report 62 at the time of creation. In another example, it may be possible to edit the verifiable condition report 62. The edited verifiable condition report may be saved as a separate file from the verifiable condition report 62 or the edits to the verifiable condition report may be stored with new creation date 66, creation location 68, and individual identifier 70.

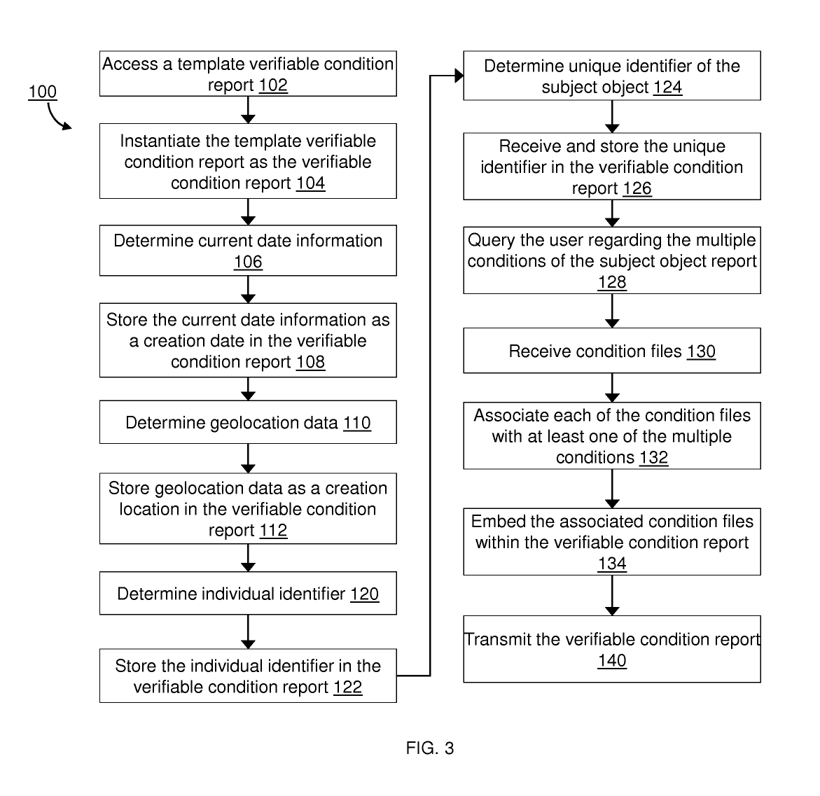

Turning to FIG. 3, a method 100 for generating a verifiable condition report 62 using a mobile device 12 is shown. As will be understood by one of ordinary skill in the art, the method 100 may be performed by the processor 20 of the mobile device 12. In process block 102, a template verifiable condition report 60 is accessed from a non-transitory computer readable medium 18 of the mobile device 12. The template verifiable condition report identifies multiple conditions.

In process block 104, the template verifiable condition report 60 is instantiated as the verifiable condition report 62. In process block 106, a processor 20 of the mobile device 12 queries to determine current date information. In process block 108, the current date information is stored as a creation date 66 in the verifiable condition report 62.

In process block 110, a geolocation module 14 of the mobile device 12 is queried to determine geolocation data indicating a position of the mobile device 12. In process block 112, the geolocation data is stored as a creation location 68 in the verifiable condition report 62.

In process block 120, an individual identifier associated with either the mobile device 12 or a user of the mobile device is determined. In process block 122, the individual identifier is stored in the verifiable condition report 62.

In process block 124, a user of the mobile device 12 is queried for a unique identifier of a subject object. In process block 126, the unique identifier of the subject object is received and stored in the verifiable condition report 62.

In process block 128, a user of the mobile device 12 is queried regarding the multiple conditions 74 of the subject object included in the verifiable condition report 62. In process block 130, condition files 72 evidencing a particular condition of the subject object are received from a recording module 16 of the mobile device 12. In process block 132, each of the condition files 72 is associated with at least one of the multiple conditions 74 of the subject object. In process block 134, the associated condition files are embedded within the verifiable condition report 62. In process block 140, the verifiable condition report 62 is transmitted via a network interface 22 of the mobile device 12.

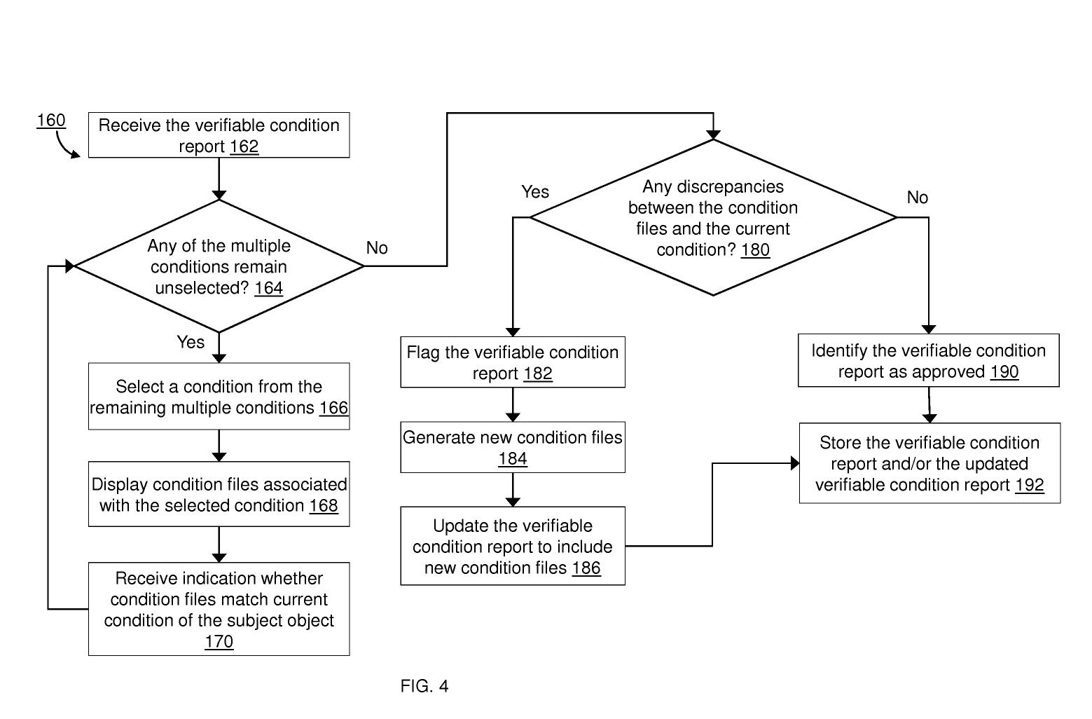

Turning to FIG. 4, a method 160 for creating and validating a verifiable condition report 62 is shown. As will be understood by one of ordinary skill in the art, the method 160 may be performed by the processor 42 of the portable device 40. In process block 162, the verifiable condition report is received. In decision block 164, a determination is made regarding whether each of the multiple conditions has been analyzed. In process block 166, if all of the multiple conditions have not been analyzed, then a new condition from the multiple conditions is selected. In process block 168, the condition files associated with the selected condition are displayed to a user. In process block 170, an indication from the user regarding whether the condition files associated with the selected condition of the subject object match a current condition of the subject object is received.

In decision block 180, after each of the multiple conditions have been analyzed, a determination is made regarding whether the received indication from the user identifies a discrepancy between the verifiable condition report and the current condition of the subject object. If there is a discrepancy, the method moves to process block 182. In process block 182, the verifiable condition report 60 is flagged. In process block 184, at least one new condition file evidencing the condition of the subject object associated with the discrepancy is generated. The at least one new condition file may be generated by an image forming device (not shown) of the portable device 40. In process block 186, the verifiable condition report 62 is updated to include the at least one new condition file 76.

If the received indication from the user does not identify a discrepancy between the verifiable condition report and the current condition of the subject object in decision block 180, then the method moves to process block 190. In process block 190, the verifiable condition report is identified as approved. In process block 192, the identified verifiable condition report 62 and/or the updated verifiable condition report 63 is stored. The verifiable condition report 62 and/or updated verifiable condition report 63 may be transmitted by a communication interface 46 of the portable device 40 to the server 30.

As will be understood by one of ordinary skill in the art, the mobile device 12 and portable device 40 may comprise any suitable electronic device. For example, either or both of the mobile device 12 and portable device 40 may comprise any of a mobile phone, tablet computer, laptop, or personal data assistant (PDA).

As will be understood by one of ordinary skill in the art, the server 30 may comprise any suitable computing device configured to receive and transmit files and information via the network 24. For example the server 30 may comprise an enterprise server, desktop computer, or personal computer.

As will be understood by one of ordinary skill in the art, the verifiable condition report 62, template verifiable condition report 60, and updated verifiable condition report 63 may be stored in any suitable format. The format that the reports are stored in may depend on the intended recipient of the reports, the type of subject object, etc.

The verifiable condition report 62 is not limited to containing the data and information described herein. Rather, the verifiable condition report 62 may include any other suitable information related to the subject object. For example, the verifiable condition report 62 may include the pickup location, drop off location, means of transportation, identification of a transporting vehicle, pickup date, drop off date, name of transporter, etc.

Although the present disclosure has been shown and described with respect to a certain illustrated embodiment or embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiment or embodiments of the present disclosure.

1. A mobile device configured to generate a verifiable condition report, the mobile device comprising:
a geolocation module configured to output geolocation data indicating a position of the mobile device;
a recording module configured to output condition files evidencing a condition of a target object;
a non-transitory computer readable medium configured to store a template condition report, wherein the template verifiable condition report identifies multiple conditions;
a processor configured to generate the verifiable condition report from the template condition report by:
instantiating the template verifiable condition report as the verifiable condition report;
determining current date information;
storing the current date information as a creation date in the verifiable condition report;
receiving geolocation data from the geolocation module;
storing the geolocation data as a creation location in the verifiable condition report;
determining an individual identifier associated with either the mobile device or a user of the mobile device;
storing the individual identifier in the verifiable condition report;
receiving and storing the unique identifier of the subject object in the verifiable condition report;
receiving condition files from the recording module evidencing a particular condition of the subject object;
associating each of the condition files with at least one of the multiple conditions of the subject object; and
embedding the associated condition files within the verifiable condition report; and
a network interface configured to transmit the verifiable condition report.

2. The mobile device of claim 1, wherein the individual identifier comprises at least one of a mobile device identifier identifying the mobile device or a user identifier identifying the user of the mobile device.

3. The mobile device of claim 2, wherein the processor:
receives the user identifier and a password;
causes the network interface to transmit the received user identifier and the password to an authenticating server; and
receives a verification from the authenticating server via the network interface when the user identifier and the password are valid.

4. The mobile device of claim 2, wherein the mobile device identifier comprises a serial number or MAC address of the mobile device.

5. The mobile device of claim 2, wherein the geolocation module comprises a GPS receiver.

6. The mobile device of claim 1, wherein the recording module comprises an image capturing module, a video capturing module, or an audio capturing module.

7. A method for generating a verifiable condition report using a mobile device, the method comprising:
accessing a template verifiable condition report from a non-transitory computer readable medium of the mobile device, wherein the template verifiable condition report identifies multiple conditions;
instantiating the template verifiable condition report as the verifiable condition report;
querying a processor of the mobile device to determine current date information;
storing the current date information as a creation date in the verifiable condition report;
querying a geolocation module of the mobile device to determine geolocation data indicating a position of the mobile device;
storing the geolocation data as a creation location in the verifiable condition report;
determining an individual identifier associated with either the mobile device or a user of the mobile device;
storing the individual identifier in the verifiable condition report;
querying a user of the mobile device for a unique identifier of a subject object;
receiving and storing the unique identifier of the subject object in the verifiable condition report;
querying a user of the mobile device regarding the multiple conditions of the subject object included in the verifiable condition report;
receiving condition files evidencing a particular condition of the subject object from a recording module of the mobile device;
associating each of the condition files with at least one of the multiple conditions of the subject object;
embedding the associated condition files within the verifiable condition report; and
transmitting the verifiable condition report via a network interface of the mobile device.

8. The method of claim 7, wherein the individual identifier comprises at least one of a mobile device identifier identifying the mobile device or a user identifier identifying the user of the mobile device.

9. The method of claim 8, wherein the mobile device identifier comprises a serial number or MAC address of the mobile device.

10. The method of claim 8, wherein the geolocation module comprises a GPS receiver.

11. The method of claim 7, wherein the recording module comprises an image capturing module, a video capturing module, or an audio capturing module.

12. A method for creating and validating a verifiable condition report, the method including:
generating a verifiable condition report using a mobile device as set forth in claim 7;
receiving the verifiable condition report;
for each of the multiple conditions identified in the verifiable condition report, causing to be displayed to a user the condition files associated with a particular condition of the subject object and receiving an indication from the user regarding whether the condition files associated with the particular condition of the subject object match a current condition of the subject object;
if the received indication from the user identifies a discrepancy between the verifiable condition report and the current condition of the subject object:
flagging the verifiable condition report;
generating at least one new condition file evidencing the condition of the subject object associated with the discrepancy; and
updating the verifiable condition report to include the at least one new condition file;
if the received indication from the user does not identify a discrepancy between the verifiable condition report and the current condition of the subject object, identifying the verifiable condition report as approved;
storing the verifiable condition report.

13. The method of claim 12, wherein the verifiable condition report is received by a portable device and the at least one new condition file are generated by an image forming device, a video forming device, or an audio forming device of the portable device.

14. The method of claim 13, wherein the verifiable condition report is transmitted by a communication interface of the portable device to a server.

15. A system configured to create and validate a verifiable condition report, the system comprising:
a mobile device including:
a geolocation module configured to output geolocation data indicating a position of the mobile device;
a recording module configured to output condition files evidencing a condition of a target object;
a non-transitory computer readable medium configured to store a template condition report, wherein the template verifiable condition report identifies multiple conditions;
a processor configured to generate the verifiable condition report from the template condition report by:
instantiating the template verifiable condition report as the verifiable condition report;
determining current date information;
storing the current date information as a creation date in the verifiable condition report;
receiving geolocation data from the geolocation module;
storing the geolocation data as a creation location in the verifiable condition report;
determining an individual identifier associated with either the mobile device or a user of the mobile device;
storing the individual identifier in the verifiable condition report;
receiving and storing the unique identifier of the subject object in the verifiable condition report;
receiving condition files from the recording module evidencing a condition of the subject object;
associating each of the condition files with at least one of the multiple conditions of the subject object; and
embedding the associated condition files within the verifiable condition report;
a network interface configured to transmit the verifiable condition report to a server;
the server including:
a connection interface configured to receive the verifiable condition report;
a non-transitory computer readable memory configured to store the received verifiable condition report;
the connection interface further configured to transmit the verifiable condition report to a portable device;
the portable device including:
a communication interface configured to receive the verifiable condition report;
a processor configured to flag or approve the verifiable condition report by:
receiving the verifiable condition report;
for each of the multiple conditions identified in the verifiable condition report, causing to be displayed to a user of the portable device the condition files associated with a particular condition of the subject object and receiving an indication from the user regarding whether the condition files associated with the particular condition of the subject object match a current condition of the subject object;
if the received indication from the user identifies a discrepancy between the verifiable condition report and the current condition of the subject object:
flagging the verifiable condition report;
generating at least one new condition file evidencing the condition of the subject object associated with the discrepancy; and
updating the verifiable condition report to include the at least one new condition file;
if the received indication from the user does not identify a discrepancy between the verifiable condition report and the current condition of the subject object, identifying the verifiable condition report as approved;
a non-transitory computer readable medium configured to store the flagged or approved identified verifiable condition report.

16. The system of claim 15, wherein the individual identifier comprises at least one of a mobile device identifier identifying the mobile device or a user identifier identifying the user of the mobile device.

17. The system of claim 16, wherein the processor of the mobile device:
receives the user identifier and a password;
causes the network interface to transmit the received user identifier and the password to an authenticating server; and
receives a verification from the authenticating server via the network interface when the user identifier and the password are valid.

18. The system of claim 16, wherein the mobile device identifier comprises a serial number or MAC address of the mobile device.

19. The system of claim 16, wherein the geolocation module comprises a GPS receiver.

20. The system of claim 15, wherein the recording module comprises an image capturing module, a video capturing module, or an audio capturing module.
